(19) United States
(12) Patent Application Publication
(10) Pub. No.: US 2009/0315301 A1
(43) Pub. Date: Dec. 24, 2009

(54) Scooter luggage

(76) Inventor: Ravi Athalye, (US)

Correspondence Address: Ravi G Athalye, 5011 W Lake SAMM Pkway NE, Redmond, WA, 98052, US

(21) Appl. No.: 12/214,445

(22) Filed: Jun. 18, 2008

(51) Int. Cl. B62B 3/12

(52) U.S. Cl. 280/651

(57) ABSTRACT

Globalization has created a culture of frequent air travel. This has in turn required the luggage to be optimized for effortless transport and sized to conform to storage compartments available on airplanes. The Roll On wheeled luggage that is sized to fit in the overhead bins in the plane has become popular with the short stay frequent traveler since it eliminates the time involved in checking in the luggage for storage in the plane undercarriage. The current invention, called the Scooter Luggage is for the needs of the extremely mobile and agile population. Scooter Luggage converts the conventional Roll On wheeled luggage to a three wheeled scooter. It integrates a third wheel, a platform to stand and a steering mechanism that enables the user to use the luggage to scoot from terminal to terminal. The design is foldable so that the luggage still conforms to the air plane overhead bin format. It also has a miniature fork lift feature so that the Scooter Luggage can be loaded with other items for transporting. The Scooter Luggage is configurable for airport shopping convenience. The Scooter Luggage retains the functionality of a conventional Roll On luggage

### FIELD OF THE INVENTION

Globalization has brought on a culture of frequent travel which in turn has caused modification of luggage used for travel. The features and size of modern luggage have altered for convenience of transport and ease of air travel. The Roll On wheeled luggage that is sized to fit in the overhead bins in the plane has become popular with the short stay frequent traveler. The luggage reduces time to check in and to leave the airport as well as enables effortless moving between terminals for flights change. The current invention Scooter Luggage is for the mobile and agile population. The invention converts the conventional Roll On wheeled luggage to a wheeled scooter. It integrates at least a third wheel, a platform to stand and a steering mechanism that enables the user to use the luggage to scoot from terminal to terminal. The design is foldable so that the luggage still conforms to the air plane overhead bin format. It also has a miniature fork lift feature so that the Scooter Luggage can be loaded with other items for transporting. The Scooter Luggage retains the functionality for use like conventional Roll On luggage when the third wheel and platform is folded away. The configuration opens up scope for redesign of the luggage container so that it can be used in a shopping cart mode. As a transporting vehicle it has a brake to facilitate use of the scooter luggage in public places. The features lend themselves to other sizes of luggage appealing to the very young to the mature and agile populace.

### BACKGROUND OF THE INVENTION

Luggage has evolved with the needs of the frequent Global Traveler. The modern frequent flyers need the flexibility to change the flight from the scheduled to the unscheduled in response to flight cancellations or availability of an earlier flight. This flexibility is possible if the luggage can be carried on board in the passenger area and be able to be stored in overhead bins in the airplanes. The wheels on the luggage facilitate effortless movement of the luggage. The luggage is dimensioned to the overhead bin dimensions in airplanes. The modern frequent flyer is mobile, agile and often unconventional. The Scooter Luggage converts to a personal transporter, enabling the traveler to scoot between terminals quickly and pleasantly without giving up the functionalities of the conventional Roll On luggage. With a built in fork lift it also has facility to carry additional items. The configuration opens up scope for redesign of the luggage container so that it can be used in a shopping cart mode.

### PRIOR ART

There are various patents to limit the dimension of the luggage, the locking mechanism of the fold up handles and the wheeled mechanism to roll the luggage.

However there is no prior art that shows the luggage to be used as a transportation vehicle.

### SUMMARY OF THE INVENTION

It is the primary object of the present invention to provide a method to be able to use the luggage as a transporting vehicle.

Another object of the invention is to enable the luggage to be able to be used as a light forklift to carry additional items that may be part of the travel.

Another object of the invention is to enable the luggage to be pulled and moved like a conventional luggage without the scooter transportable feature.

Another object of the invention is to enable the luggage to be used as a shopping cart when used in the Scooter configuration.

Another object of the invention is to enable the features to be able to be provided in a physical format suitable for the overhead bins of a airplane.

### BRIEF DESCRIPTION OF DRAWINGS (PREFERRED EMBODIMENT)

FIG. 1 is the side elevation of the Scooter Luggage with handle in the open position, the prongs of the fork lift feature folded position and the scooter platform in the latched position for ‘scooting’.

FIG. 2 is the side elevation of the container depicting the ledge on which the wheeled platform rest. The elevation is without any of the Scooter Luggage features.

FIG. 3 is the side elevation of the Scooter Luggage when the handle is folded away, the prongs of the fork lift in the folded position and the scooter platform folded away in the recess of the container.

FIG. 4 is another elevation from the side of the Scooter Luggage with the wheeled platform.

FIG. 5 is the Plan of the view of FIG. 1.

FIG. 6 shows the schematic of disposition of the three wheels and the movement associated with the steering of the Scooter Luggage.

FIG. 7 shows the side elevation of the Sleeve, Axle coupling with the platform with wheel and the stem that is used to latch the platform in the open position.

FIG. 8 shows the Scooter Luggage in the configuration when it resembles the conventional Roll On luggage.

FIG. 9 is the side elevation of the Scooter Luggage in a configuration with the platform in the open position, the handle in the open position to enable it to function as steering handle and the fork prongs open with a load set on the prongs.

FIG. 10 shows the magnified plan of the Scooter Luggage steering handle sectioned transverse to the steering column at the point of latching with the locking pin.

FIG. 11 shows the Scooter Luggage container configured into compartments that allow it to be used as a shopping cart when browsing the airport shops.

FIG. 12 depicts the rear platform of the Scooter Luggage.

33 is the side elevation of the platform of the Scooter Luggage. 30 is the hood cover of the third wheel. 31 is the brake pedal that brakes the Scooter luggage when stepped on. 32 is the third wheel of the

### DETAILED DESCRIPTION OF DRAWINGS

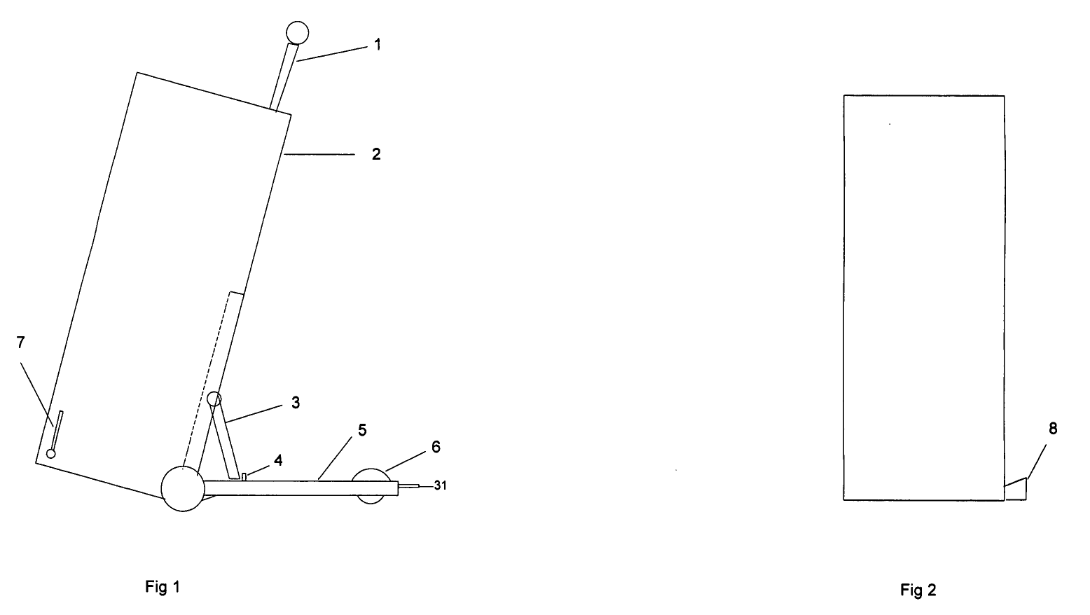

FIG. 1 shows the side elevation of the Scooter Luggage with the handle extended, the third scooter wheel and platform in the operational position and the locking stem in the locked position with the platform. The various components are described as:

1 fold away handle with open and closed latched positions

2 luggage container

3 hinged stem that locks the platform in the open position. It is designed to move with the steering motion between the luggage container and the platform.

4 is the platform boss that captures the stem to latch the platform in open position.

5 is the scooter platform for the user to place one foot while the other foot is pushed against the floor to propel the scooter.

6 is the third wheel that forms a stable system in co operation with the two wheels of the luggage.

7 is on element of the pair of forks. It is shown in the stored position.

FIG. 2 depicts the elevation of the luggage without any of its functional components except bottom ledge on which the platform rest when it is folded out for scooting operation. The upper plane of the ledge is angled to provide the leaning stance the luggage adopts during scooting.

8 is the ledge that the platform 5 rest on in the open position.

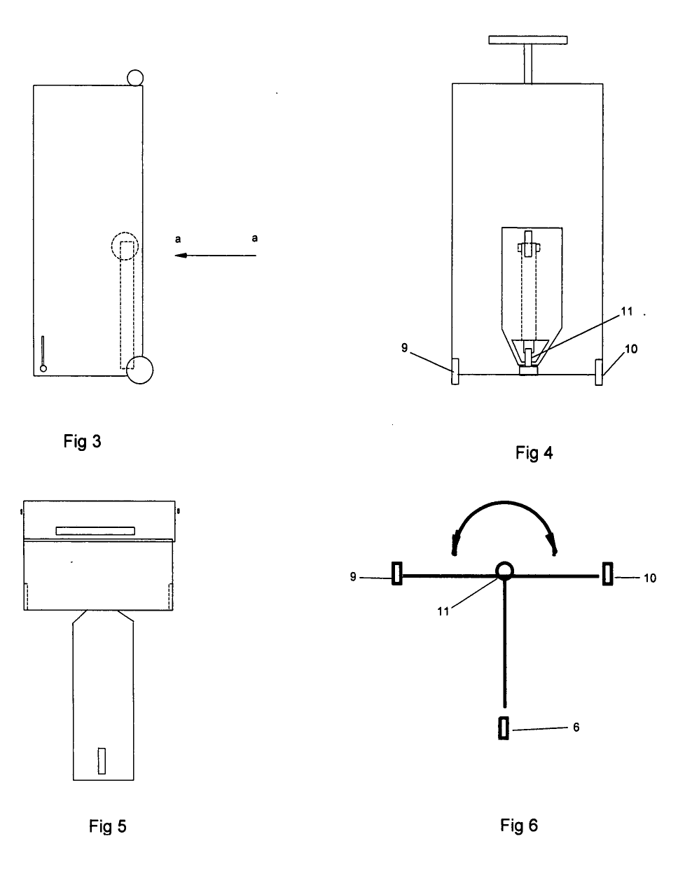

FIG. 3 depicts the side elevation of the Scooter Luggage with the handle folded in and the third wheel with platform folded in a mode when the luggage is ready to be loaded into the overhead bin of an airplane.

FIG. 4 depicts the elevation as seen from the direction of a-a shown in FIG. 3. The handle is in the operational position. The platform and the third wheel in the folded up latched position.

9,10 are the wheels of the luggage for operating the scooter in the Roll On configuration. FIG. 5 is the plan of FIG. 1 with the platform exaggerated in length to show the relationship of the open platform.

FIG. 6 is a schematic to show the steering functionality. The platform hinges around the axis of the sleeve placed at the mid point of the distance between the two wheels of the luggage and affixed to the luggage container.

9,10,6 are the three wheels of the scooter.

11, is the orthogonal sleeve with axis 12.

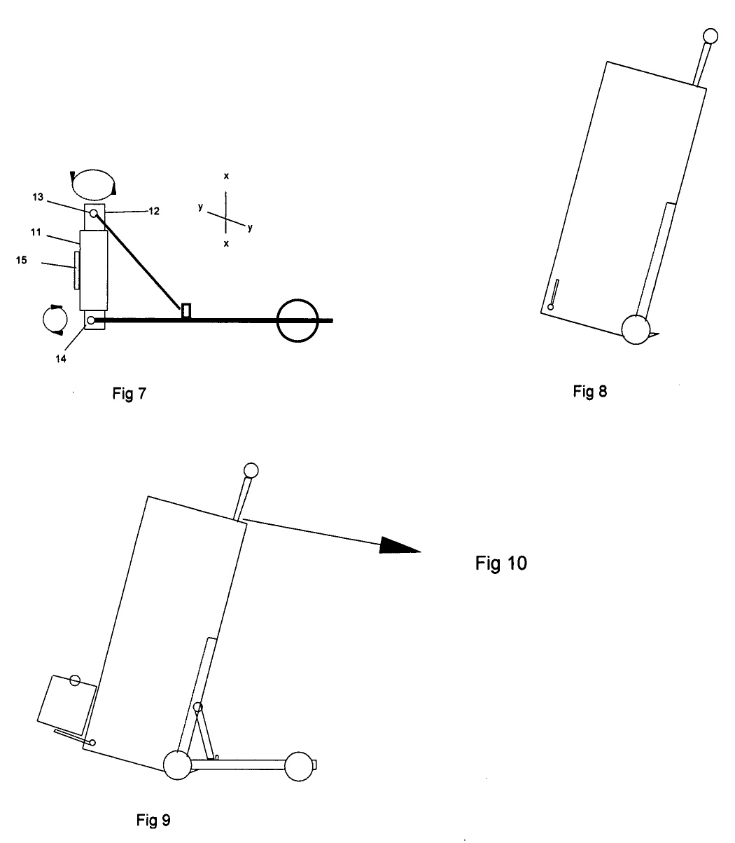

FIG. 7 is a schematic concept of the hinge that is a pivot for the steering of the luggage and the pivot for the locking stem and the platform.

11, is the orthogonal hinge

12 is the moving axis of the hinge that has bearings between the sleeve and the axis to enable friction free movement between the platform and the luggage container.

13 is the hinge around which the stem can pivot to be able to be stored in the recess of the luggage container in the non operational mode.

14 is the hinge for the platform to pivot identical to the motion of the stem 3 in FIG. 1

15 is the weld joint or attaching means of the outer sleeve of the orthogonal hinge with the luggage side.

FIG. 8 depicts the Roll On mode of the Scooter Luggage.

FIG. 9 depicts the Forklift mode of the Scooter Luggage with a piece of luggage loaded on the forklift prongs.

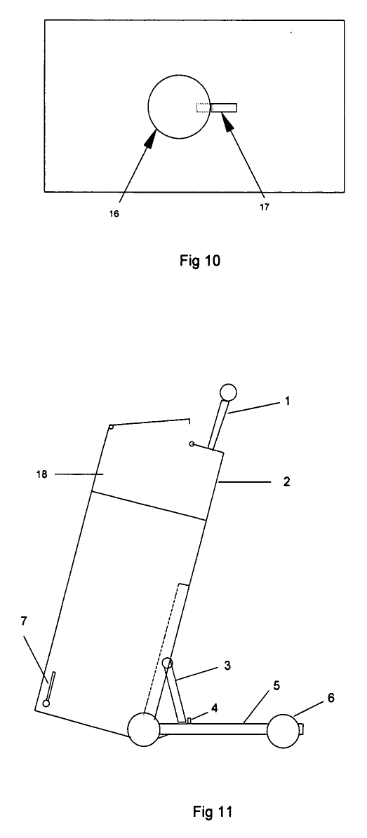

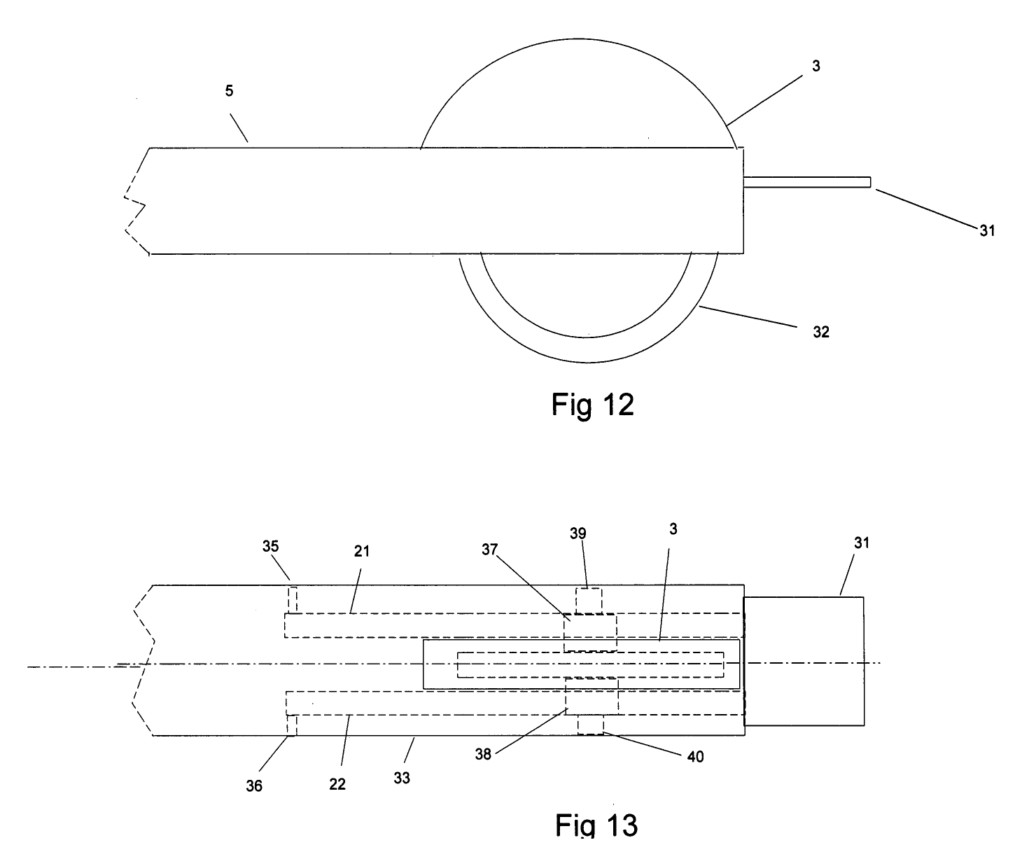

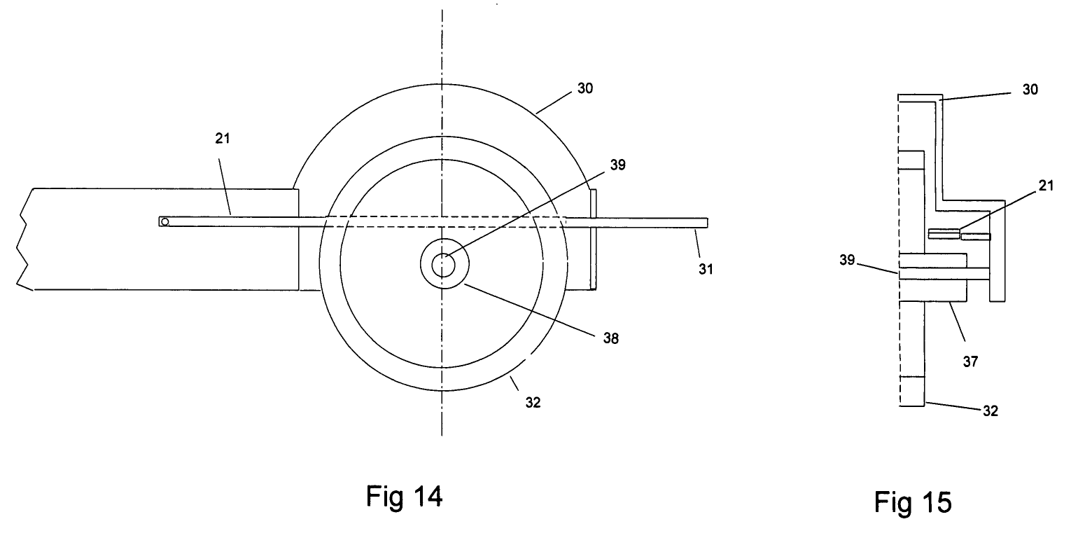

FIG. 10 is the plan of the column of the steering handle at the plane of latching the steering column with a sliding transverse pin. 16 is the section of the steering column and 17 is the transverse sliding pin that prevents the steering column from collapsing and rotationally locking the column with the container of the Scooter Luggage. 17 can be slid into the steering column for locking and out of it to enable it to collapse.

FIG. 11 is the side elevation of the Scooter Luggage in a shopping cart configuration Compartment 18 is provided with an opening cover located on the top while using the luggage in the Scooter configuration for easy access to storage space for items purchased while browsing the airport shops.

Function

The invention called the Scooter Luggage consists of the following modifications to the conventional Roll On two wheel luggages:
The fold away handle has a locking feature that prevents the handle from collapsing while the luggage is used as scooter.
The luggage container sides are provided with insets to fold away the scooter third wheel and platform and lock them in place.
The luggage edge is modified to provide a ledge for the platform to be locked into its position when used as a scooter.
A combination of a sleeve with a movable axle within is affixed at approximately mid way point between the two wheels of the conventional Roll On luggage orthogonal to the axis between the wheels of the luggage. The axle ends have hinges transverse to the axle. One hinge connects to the wheeled platform and the other to a moving stem.
The axle hinge combination enables the Scooter Luggage to be steered via the fold away handle of the luggage.
The sleeve with the axle coupling to the platform enables the Scooter Bag to be steered while the user stands on the platform.
The Scooter Luggage can be used in 3 modes:
   Mode 1 like a conventional Roll On luggage by using the handle and the third wheel folded up.
   Forklift mode with the fork lift arms unfolded. This mode can be operated in Roll On or Scooter mode.
   Scooter mode with the platform folded out and latched and using the handle to steer the luggage.

### DESCRIPTION OF THE PREFERRED EMBODIMENT

It is understood that the concept can be reduced to practice in any number of combinations of joints, hinges, latches and wheel configuration. The various combinations that enable a luggage to be converted to a transport means are within the claims of the invention the Scooter Luggage.

The embodiment presented is based on a three wheel configuration with the bag handle in the fully extended position as a steering handle. It is understood that the concept could have two wheels or four wheels depending on the interpretation of the objectives. The current configuration utilizes the standard rolling wheels for steering but other configurations wherein the standard wheels are locked straight while the third wheel is steered are possible. All these combinations are part of the transportation objectives of this patent.

The Scooter Luggage conforms to the dimensions of the overhead bin of airplanes to enable the luggage to be taken on board the plane and stored in the overhead bin. The Scooter Luggage has three modes of use:
Used as a conventional Roll on luggage
Used as a forklift that can be used to carry additional items like a forklift
Used as a Scooter by a fold-out platform with a wheel.

The design can be built into luggage that has larger dimensions.

The elements that characterize the Scooter Luggage are:
Sealable container comprising of space for storing items used in transporting.
Sealable container has affixed two parallel wheels in the manner of a wheel barrow.
A fold out latch able handles that positions the handle for conveniently pulling or pushing the luggage as it rolls on wheels.
Twin fold out prongs along side of the luggage that is stable in two positions. One position for storing away and the other for use as prongs of a forklift
A fold out platform with a wheel that forms a vertex of a triangle formed with the two wheels affixed to the container.
The fold out platform has two stable positions. One when folded away and the other when folded out creating a three wheeled platform, the platform being rotationally coupled to the bag thereby allowing relative rotational movement between the platform wheel and the container wheels.
A latching stem that folds out to enable the scooter platform to be latched in the open operational position. The latching stem being also rotationally coupled between the platform and the container, to enable the latch to be functional without arresting the platform rotation.
The latching stem is stable in two positions: folded away and folded out and being capable of being latched in the two position.
The platform and the stem are connected to the two opposite ends of an axle that runs through a sleeve. The sleeve is affixed to the container approximately mid way between the wheels of the container along the outer surface of the container.
The platform and latching stem are capable of being rotated in a plane orthogonal to the plane of rotation of the axis in the sleeve. This enables the platform and stem to be folded away when not in use.
The entire system when operated as a scooter creates:
   A container with handle folded out acting as a steering handle
   Fork prongs folded out creating cantilevers for carrying items.
   The platform folded out and latched with the latching stem creating a platform for carrying a person.
   The steering handle along with the platform creating the steer able scooter function.
The entire system when folded away takes the form of a luggage bag of format suitable for storage in overhead bin of airplanes.

I claim:

1. Scooter Luggage with:
a container for storing luggage,
container provided with surface recesses for accommodation of components of the system of scooter luggage,
a pair of parallel wheels for the container for enabling the luggage to be rolled in the manner of a wheel barrow,
additional at least one wheel for enabling the luggage container to support a platform for transporting a passenger,
platform coupled to the luggage container and at least one wheel suitable for supporting a passenger,
the platform hinged to the luggage container in a manner that it can be folded and latched to the luggage container,
a collapsible handle that is capable of being latched in the open and closed position,
the entire system described above to function as a luggage container that can function like a wheel barrow or a transportation system capable of carrying a passenger and steer able while the passenger propels the system with body supported on the platform and one leg used as a thruster by pushing on the ground.

2. Scooter Luggage with:
a container for storing luggage,
container provided with surface recesses for accommodation of components of the system of scooter luggage,
a pair of parallel wheels for the container for enabling the luggage to be rolled in the manner of a wheel barrow,
a collapsible handle that is capable of being latched in the open and closed position,
a hinged platform that has a wheel positioned to form a triangle with the pair of wheels on the luggage container, the platform being capable of being folded into the recess of the luggage container sides and being capable of being latched in the open position to form a stable base strong enough to carry the weight of a person,
sleeve with movable axle, with one end of the axle affixed to the platform hinge to enable free movement of the platform with respect to the luggage container, the sleeve surface affixed to the container substantially mid point between the container wheels, along the container surface,
the stem hinge affixed to the other end of the axle whose movement is orthogonal to the plane of the platform, the hinge coupled to a stem to allow movement of the stem such that it can be folded into the recesses of the luggage in the non operational mode, the stem being latched with a boss within the container recess, as also to allow stem to fold out and latch the platform in the open position,
a boss in the platform that co operates with the stem to lock the stem with the platform,
the handle, luggage container and wheels of the luggage being able to be moved with respect to the platform, the platform being capable of supporting a person and enabling the wheels on the luggage to be steered in a desired direction by using the handle of the luggage as a steering handle and the entire system being able to function like a scooter,
container compartments configured so that one of the compartment opens on the side facing up when the Scooter Luggage is used as a scooter.

3. The system of claim two provided with a pair of fork prongs that can be latched in two positions, one for storage and the other for supporting loads on the forks, the latching in closed position being accomplished by two bosses that create interference obstacles to the forklift prong movements and two bosses in the open position that support the prongs in the open position.

4. A system consisting of
container provided with configurable arrangement of wheels, steering arrangement, wheeled platform and load bearing members that enables the system to be configured based on type of use, namely,
1. container for luggage that can be moved on wheels by pushing or pulling a fold away handle,
2. container for luggage as in 1 that can be moved on wheels can be configured to form a wheel barrow for transport of additional load along with the container,
3. container for luggage as in 2 that can be moved on wheels can be configured to be a transport means by provision of built in fold away wheeled platform and the use of the container handle to form a steering arrangement,
4. system as in 3 above be dimensioned to conform to the storage dimensions on board the passenger cabin,
5. system as in 4 above with compartments configured with the top compartment suitable for use as shopping cart.
